(19) United States
(12) Patent Application Publication
(10) Pub. No.: US 2008/0319613 A1
(43) Pub. Date: Dec. 25, 2008

(54) Turning Behavior Control Apparatus and Turning Behavior Control Process for a Motor Vehicle

(75) Inventors: Yutaka Mikuriya, Kanagawa (JP); Takuma Suzuki, Chiba (JP); Tadashi Tamasho, Chiba (JP)

Correspondence Address: YOUNG & BASILE, P.C., 3001 WEST BIG BEAVER ROAD, SUITE 624, TROY, MI, 48084, US

(73) Assignee: Nissan Motor Co., Ltd., Yokohama-shi, Kanagawa (JP)

(21) Appl. No.: 12/279,587

(22) PCT Filed: Feb. 15, 2007
(86) PCT No.: PCT/IB07/50502

§ 371 Date: Aug. 15, 2008

(30) Foreign Application Priority Data
Feb. 16, 2006 (JP) 2006-039647

(51) Int. Cl. B62D 6/00; B62D 7/15

(52) U.S. Cl. 701/42; 701/44

(57) ABSTRACT

A turning behavior control apparatus and turning behavior control process for a motor vehicle is disclosed. The apparatus is configured to set a target vehicle turning behavior (such as the target side slip angle and the target yaw rate) in accordance with a driver's steering operation, to independently set a target vehicle yaw direction, to modify the target vehicle turning behavior in accordance with the target vehicle yaw direction, to calculate target front and rear wheel steer angles in accordance with the modified target turning behavior and to control steer mechanisms in accordance therewith.

### TECHNICAL FIELD

The present invention relates to a turning behavior control apparatus and a turning behavior control process for a motor vehicle. Aspects of the invention also relate to a vehicle

### BACKGROUND

Japanese published patent application JP 2001-334951 discloses a four wheel steering system arranged to set a geometric target turning center position and to control a rear wheel steer angle on the basis of the set target turning center position in order to adjust the yawing direction of the vehicle body during a turning movement of the vehicle.

The conventional system of the above-mentioned patent document is arranged merely to set the geometric turning center position, and the system is arranged to control the turning path and the direction of the vehicle body geometrically. However, this system takes no account of dynamic characteristics of the vehicle. Therefore, the steer angle control tends to be discontinuous in a transient motion, and the turning behavior may be inconstant.

It is an object of the present invention to address this issue and to improve upon known technology. Embodiments of the invention provide an apparatus and/or process for controlling a turning behavior of a four wheel steer vehicle in consideration of dynamic characteristics of the vehicle. Other aims and advantages of the invention will become apparent from the following description, claims and drawings.

### SUMMARY

Aspects of the invention provide an apparatus, a method and a vehicle as claimed in the appended claims.

According to an aspect of the present invention, a turning behavior control apparatus comprises a first section such as steer mechanisms to steer front and rear wheels, respectively and a second section such as a controller configured to set a target vehicle turning behavior and a target vehicle yaw direction individually or separately, to modify the target turning behavior in accordance with the target yaw direction, and to control the first section so as to achieve the modified target turning behavior.

Within the scope of this application it is envisaged that the various aspects, embodiments, examples and alternatives set out in the preceding paragraphs, in the claims and in the following description, may be taken individually or in any combination thereof.

### BRIEF DESCRIPTION OF THE DRAWINGS

The present invention will now be described, by way of example only, with reference to the accompanying drawings in which:

FIG. 1 is a schematic view showing a vehicle equipped with a vehicle turning behavior control apparatus or control system in a first practical example according to a first embodiment of the invention

FIG. 2 is a flowchart showing a drive control process for controlling the vehicle turning behavior as performed by the control system of FIG. 1;

FIG. 3 is a block diagram showing the control system according to the embodiment of FIG. 1;

FIG. 4 is a graph illustrating a characteristic of a two wheel steering (2WS) system;

FIG. 5 is a schematic view illustrating a characteristic of a four wheel steering (4WS) system;

FIG. 6 is a schematic view showing a second practical example according to the first embodiment;

FIG. 7 is a block diagram showing a control system according to a second embodiment of the present invention;

FIGS. 8A, 8B and 8C are time charts showing one example of the calculation;

FIG. 9 is a graph showing a turning path;

FIGS. 10A and 10B are time charts showing a steering operation in a system of earlier technology;

FIGS. 11A and 11B are time charts showing a steering operation in the control system according to the second embodiment;

FIGS. 12A and 12B are time charts showing variation in the yaw rate and side slip angle; and

FIG. 13 is a block diagram showing a control system according to a third embodiment of the present invention.

### DETAILED DESCRIPTION

The following is an explanation of embodiments according to the present invention based on the drawings.

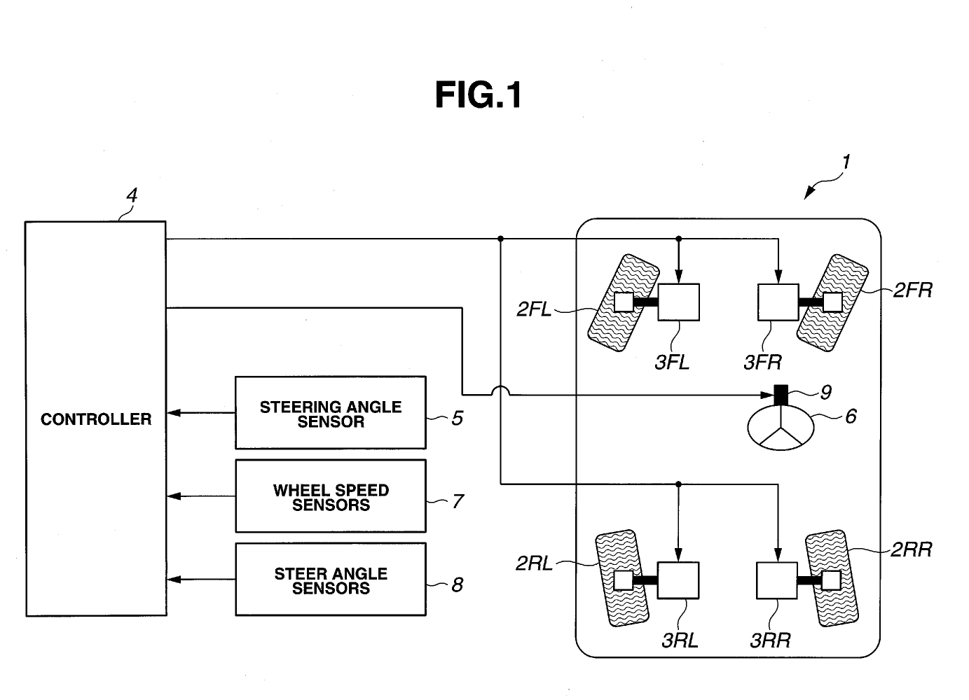

FIG. 1 is a schematic view illustrating a first embodiment according to the present invention. A motor vehicle 1 is equipped with steer mechanisms 3i capable of steering wheels 2i (i=FL, FR, RL, RR) individually. Control means in the form of a controller 4, comprising a microcomputer in this example, drivingly controls each of the steer mechanisms 3i and thereby performs a steering-by-wire in accordance with a driver's steering operation.

Each steer mechanism 3i is arranged to steer the corresponding wheel by transmitting rotation of an electric motor through a hypoid gear having an irreversible characteristic to a rack-and-pinion.

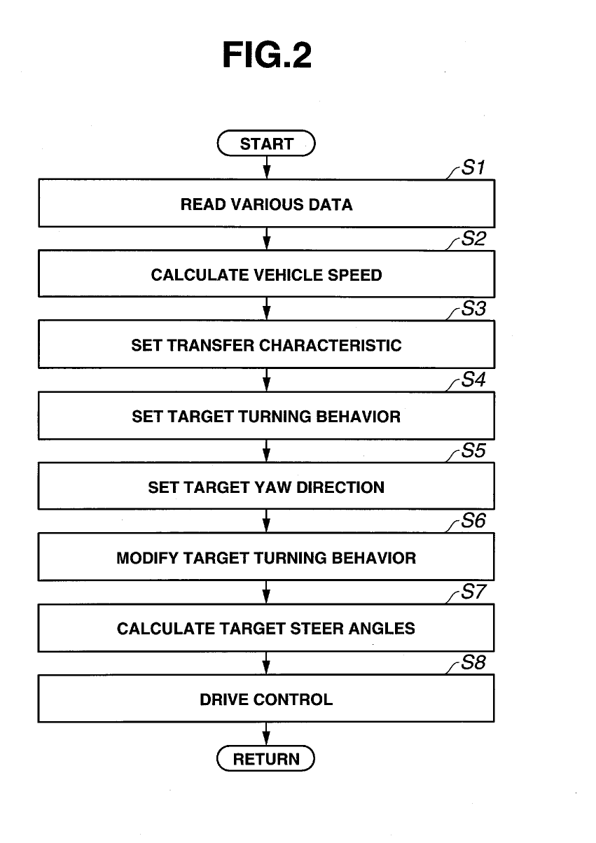

The controller 4 receives, as inputs, a steering angle θ of a steering wheel 6 as sensed by a steering angle sensor 5, a wheel speed of each wheel 2i as sensed by a respective wheel speed sensor 7, and each steer angle as sensed by a respective steer angle sensor 8. Using these inputs, the controller 4 performs a drive control process as illustrated in FIG. 2 and described later herein.

In an operation of the steering-by-wire, the controller 4 controls a driving condition of a reaction motor 9 connected in the steering system in order to provide a steering reaction force to the steering wheel 6 in response to a driver's steering operation.

Referring now to FIG. 2, this shows the drive control process performed by the controller 4 in the form of a flowchart.

At a first step S1, the controller 4 reads various data items such as the steering angle [theta], the wheel speeds and the steer angles.

At a next step S2, the controller 4 calculates a vehicle speed V from the wheel speeds.

At a next step S3, the controller 4 sets a vehicle transfer function in accordance with vehicle speed V. The controller 4 employs both static and dynamic factors in setting the vehicle transfer function. For example, a static characteristic component includes a steady state gain and a dynamic characteristic component includes natural angular frequency, a damping factor, an advance term and the like.

At a next step S4, the controller 4 sets a target turning behavior in accordance with the transfer function and the steering angle θ. This example employs, as a planar target turning behavior having two degrees of freedom, translational motion in a lateral direction (hereinafter referred to as side motion) and rotational motion in a yawing direction (hereinafter referred to as yaw motion). The controller 4 sets a target side slip angle G_{S}(s) of the vehicle body and a target yaw rate G_{Y}(s).

The target side slip angle G_{S}(s) and target yaw rate G_{Y}(s) are used as a desired target value of a traveling direction (the turning trajectory of the center of gravity of the vehicle), and the target side slip angle G_{S}(s) is used as a reference value in the yaw direction (the attitude of the vehicle body). Instead of the target side slip angle and target yaw rate, it is optional to set a target side speed and a target lateral acceleration.

At a next step S5, the controller 4 sets a target yaw direction α in accordance with a running condition such as the steering angle θ and vehicle speed V. The target yaw direction α represents a vehicle body angle (in degrees) to be added to the direction of the vehicle body obtained by the target side slip angle G_{S}(s). Instead of calculating the target yaw direction α per se, the controller 4 may be configured to receive, as an input, the target yaw direction α from an external device that calculates the target yaw direction. Moreover, the target yaw direction α may be calculated in consideration of road geometry data (such as radius of curvature and road gradient) stored in a navigation device (not shown). The target yaw direction α is a value to direct the vehicle body in a direction that is not unnatural to the driver so that the driving operation is easier for the driver in a turning movement of the vehicle along the turning path determined by the target side slip angle G_{S}(s) and target yaw rate G_{Y}(s).

At a next step S6, the controller 4 newly sets a modified target side slip angle G_{S}(s)′ and a modified target yaw rate G_{Y}(s)′ by modifying the target slip angle G_{S}(s) and target yaw rate G_{Y}(s) with the target yaw direction α as expressed by the equations below. Namely, the modified target side slip angle G_{S}(s)′ is determined by subtraction of the target yaw direction α from the product obtained by multiplying the target side slip angle G_{S}(s) by the steering angle θ. The modified target yaw rate G_{Y}(s)′ is determined by addition of a variation (derivative) sα of the target yaw direction α to the product obtained by multiplying the target yaw rate G_{Y}(s) by the steering angle θ. With this calculation, the turning path obtained from the modified target side slip angle G_{S}(s)′ and modified target yaw rate G_{Y}(s)′ after the modification is made in agreement with the turning path obtained from the unmodified target side slip angle G_{S}(s) and unmodified target yaw rate G_{Y}(s) before the modification.

G_{S}(s)′=G_{S}(s)·θ−α

G_{Y}(s)′=G_{Y}(s)·θ+sα [Eq. 1]

In this example, the modification is based on the target yaw direction α. However, it is possible to calculate a yaw rate increase γ in advance and perform the modification in accordance with this yaw rate increase γ. In other words, the calculation including subtraction of an integral ∫γdt of the yaw rate increase γ from the product of the target slip angle G_{S}(s) and steering angle θ, and addition of the yaw rate increase γ to the product of the target yaw rate G_{Y}(s) and the steering angle θ as expressed below, is equivalent to the modification of [Eq. 1] based on the target yaw direction α.

G_{S}(s)′=G_{S}(s)·θ−∫γdt

G_{Y}(s)′=G_{Y}(s)·θ+γ

At a next step S7, the controller 4 calculates a target steer angle for each wheel 2i in accordance with the modified target side slip angle G_{S}(s)′ and modified target yaw rate G_{Y}(s)′.

At a next step S8, the controller 4 controls the steer mechanisms 3i so as to bring the steer angle to the target steer angle for each wheel 2i, and thereafter returns to a main program.

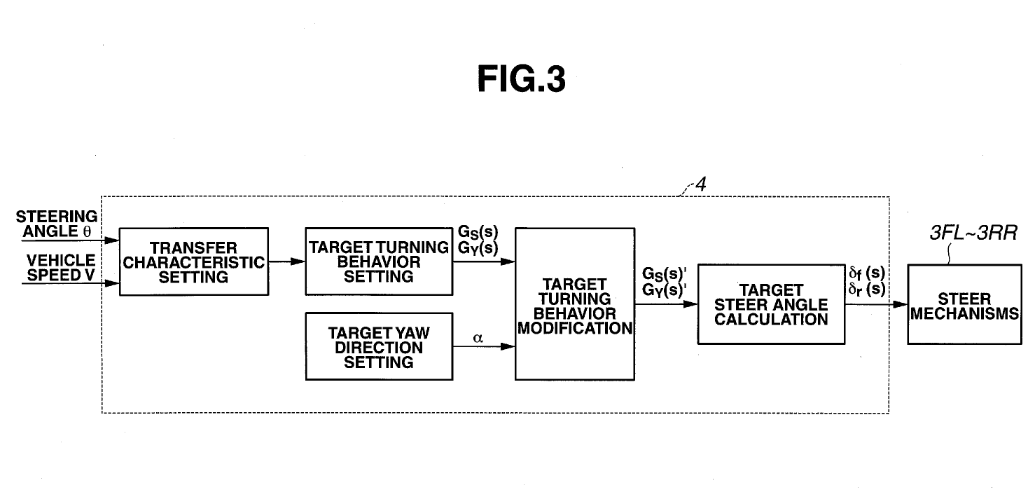

FIG. 3 is a block diagram showing the calculation process performed in the controller 4.

The turning behavior control system according to the first embodiment is operated as follows.

In the first embodiment, the controller 4 determines the target vehicle turning behavior (the target side slip angle G_{S}(s) and the target yaw rate G_{Y}(s)) and the target yaw direction α separately (at S4 and S5), modifies the target turning behavior in accordance with target yaw direction α (at S6) and controls the steer angles of the wheels 2i so as to achieve the modified target behavior G_{S}(s)′ and G_{Y}(s)′ by driving and controlling the steer mechanisms 3i (at S7 and S8).

Thus, the control system sets the target yaw direction α at a value taking into consideration the vehicle dynamics by determining the target yaw direction α independently from the target turning behavior G_{S}(s) and G_{Y}(s) and by determining the modified target turning behavior G_{S}(s)′ and G_{Y}(s)′ so as to make it possible to achieve the target yaw direction α by modifying the unmodified target turning behavior G_{S}(s) and G_{Y}(s) in accordance with the target yaw direction α.

In this case, by calculating the target turning behavior G_{S}(s) and G_{Y}(s) in accordance with the steering angle (at S4), the control system determines, as a desired target value, the accurate travel direction in accordance with the driver's steering operation.

Moreover, the controller 4 determines the transfer function in accordance with the vehicle speed (at S3) and determines the target side slip angle G_{S}(s) and target yaw rate G_{Y}(s) in accordance with the transfer function and the steering angle (at S4). By so doing, the controller 4 takes into consideration the vehicle dynamics in determining the target values.

Moreover, the controller 4 modifies the target side motion and target yaw motion so as to maintain unchanged the turning path obtained from the target side motion and target yaw motion. In other words, the controller 4 determines the modified target side slip angle G_{S}(s)′ by subtracting the target yaw direction α from the product of the target side slip angle G_{S}(s) and steering angle θ and determines the modified target yaw rate G_{Y}(s)′ by adding the variation (derivative) sα of target yaw direction α to the product of the target yaw rate G_{Y}(s) and steering angle θ (at S6). With this calculation, the control system achieves the target yaw direction α and at the same time secures the desired target turning path.

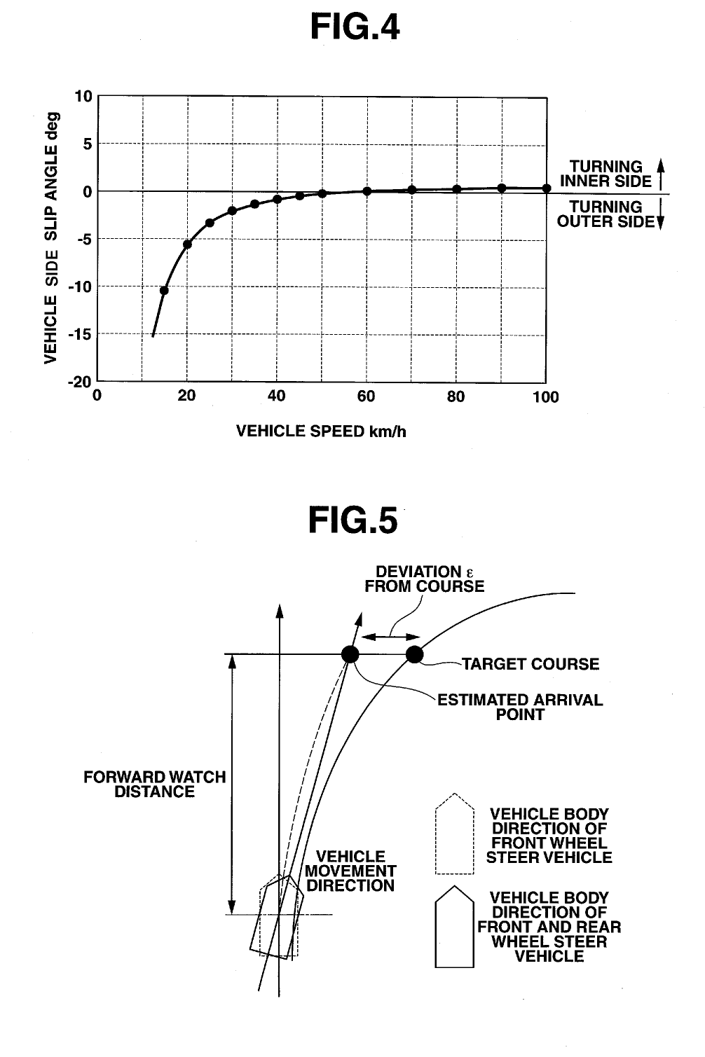

In the case of a front wheel steering (2WS) system, the direction of the rear wheels is fixed equal to the direction of the vehicle body, and therefore the vehicle side slip angle varies in accordance with the vehicle speed. For example, during a cornering operation in a front wheel steering system, the vehicle body faces more toward the outer side of the turn as the vehicle speed becomes lower and the vehicle body comes to face toward the inner side of the turn when the vehicle speed becomes higher as shown in FIG. 4. Therefore, the driver is required to think of such a characteristic and to operate the steering wheel by anticipating the turning path in dependence on the vehicle speed such that an unskilled driver tends to feel uneasy.

On the other hand, the four wheel steering (4WS) system can make significant improvements to solve such a problem. By steering the rear wheels as well as the front wheels, the four wheel steering system can make the direction of the vehicle body identical to the direction of movement of the vehicle as shown in FIG. 5. As a result, the driver can readily recognize a difference between the target course and the actual course taken by the vehicle.

The control system according to the first embodiment can set the target yaw direction α to an adequate value in consideration of the vehicle dynamic characteristics by calculating target yaw direction α independently of the target vehicle turning behavior G_{S}(s) and G_{Y}(s). Then, by modifying the target turning behavior G_{S}(s) and G_{Y}(s) with target yaw direction α, the control system can determine the modified target turning behavior G_{S}(s)′ and G_{Y}(s)′ capable of achieving the target yaw direction α. Therefore, by controlling the steer angles of the front and rear wheels in accordance with the modified target turning behavior G_{S}(s) and G_{Y}(s), the control system can stabilize the vehicle turning behavior, thereby avoiding discontinuous steer angle control during transient motion as caused by a comparative system that controls the vehicle yaw direction geometrically.

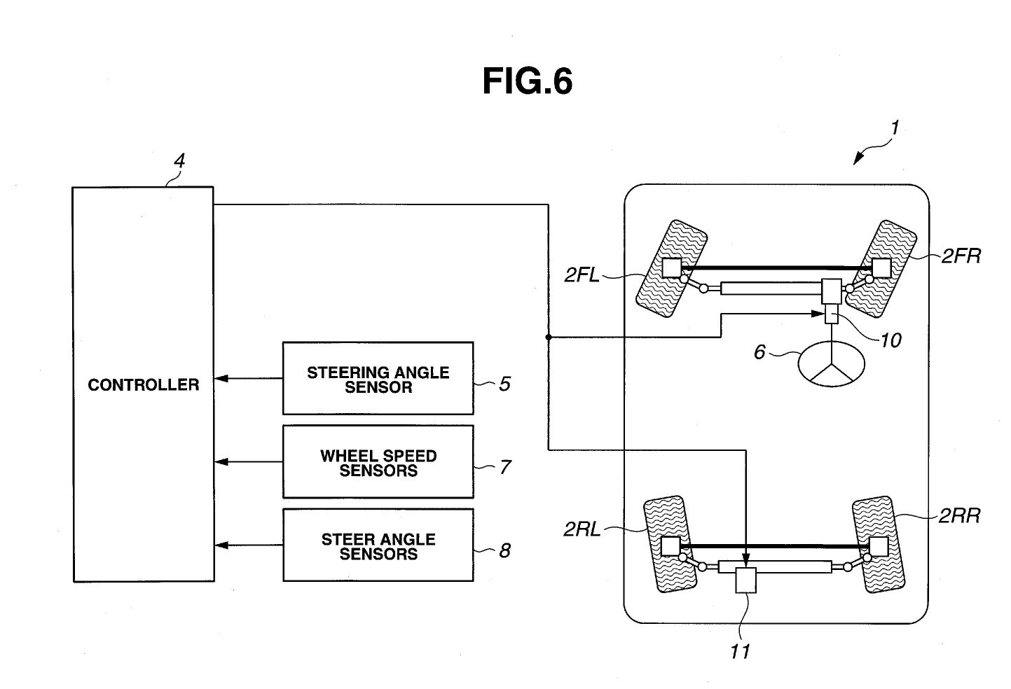

In the example shown in FIG. 1, the vehicle is equipped with four steer mechanisms 3i for steering the four wheels 2i, respectively. However, in the present invention, it is optional to employ various other steering systems capable of varying the rear wheel steer angle as well as the front wheel steer angle. For example, the steering system shown in FIG. 6 includes a steering ratio varying mechanism 10 for varying a steering angle ratio of the front wheels 2FL, 2FR, and a rear wheel steer mechanism 11 capable of steering rear wheels 2RL, 2RR. These mechanisms 10, 11 are arranged to alter the front wheel steer angle and rear wheel steer angle, respectively.

This practical example, too, can provide the same effects as in the practical example of FIG. 1.

Firstly, the control system can set the target yaw direction α in consideration of the vehicle dynamics by calculating the target yaw direction α independently from target turning behavior G_{S}(s) and G_{Y}(s) and can set the modified target turning behavior G_{S}(s)′ and G_{Y}(s)′ capable of achieving the target yaw direction α by modifying the unmodified target turning behavior G_{S}(s) and G_{Y}(s) in accordance with the target yaw direction α. Therefore, by controlling the front and rear wheel steer angles in accordance with the modified target turning behavior (G_{S}(s)′ and G_{Y}(s)′), the control system can avoid undesired continuity in the steer angle control in a transient state and thereby make the turning behavior stable.

Secondly, since the controller 4 calculates the target vehicle turning behavior in accordance with the steering angle θ, the control system can determine, as a desired target value, an adequate direction of vehicle motion in accordance with the driver's steering operation.

Thirdly, since the controller 4 calculates the target vehicle side motion G_{S}(s) and yaw motion G_{Y}(s) in accordance with the transfer function and steering angle θ, the control system according to the first embodiment can determine adequate values in consideration of the vehicle dynamic characteristics.

Fourthly, the controller 4 modifies the target side motion and target yaw motion so as to hold unchanged the turning path obtained from the above-mentioned target side motion and target yaw motion. That is, the controller 4 decreases the side motion G_{S}(s) and increases the target yaw motion G_{Y}(s) by an amount corresponding to the yaw motion of the vehicle. By so doing, the control system can achieve the target yaw direction α and at the same time maintain the desired target turning path reliably.

According to a second embodiment of the present invention, there is provided one or more vehicle models simulating vehicle dynamic characteristics, and steps S4, S6 and S7 are changed as explained below. In the other respects, the second embodiment is identical in construction and process to the first embodiment.

At S4, the controller 4 of the second embodiment sets the target side slip angle G_{S}(s) and target yaw rate G_{Y}(s) according to a linear two-degree-of-freedom model simulating the dynamic characteristics of a front wheel steering (2WS) vehicle as expressed below.

$${G}_{S} ( s ) = {G}_{S} ( 0 ) [ \frac{{T}_{S} \cdot s + 1}{\frac{{s}^{2}}{{ω}_{n}^{2}} + \frac{2 ζ s}{{ω}_{n}} + 1} ] \cdot θ \\ {G}_{Y} ( s ) = {G}_{Y} ( 0 ) [ \frac{{T}_{Y} \cdot s + 1}{\frac{{s}^{2}}{{ω}_{n}^{2}} + \frac{2 ζ s}{{ω}_{n}} + 1} ] \cdot θ \qquad [ Eq . 3 ]$$

In these equations:

$${ω}_{n} = \frac{L}{V} \sqrt{\frac{{C}_{f} {C}_{r}}{{mI}_{Z}}} \sqrt{1 + {AV}^{2}}$$

$$ζ = \frac{m ( {L}_{f}^{2} {C}_{f} + {L}_{r}^{2} {C}_{r} ) + {I}_{Z} ( {C}_{f} + {C}_{r} )}{2 L \sqrt{{mI}_{Z} {C}_{f} {C}_{r} ( 1 + {AV}^{2} )}}$$

$${G}_{S} ( 0 ) = \frac{1 - \frac{m}{L} \frac{{L}_{f}}{{L}_{r} {C}_{r}} {V}^{2}}{1 + {AV}^{2}} \frac{{L}_{r}}{L}$$

$${T}_{S} = \frac{{I}_{Z} V}{{LL}_{r} {C}_{r}} \frac{1}{1 - \frac{m}{L} \frac{{L}_{f}}{{L}_{r} {C}_{r}} {V}^{2}}$$

$${G}_{Y} ( 0 ) = \frac{1}{1 + {AV}^{2}} \frac{V}{L}$$

$${T}_{Y} = \frac{m {L}_{f} V}{{LC}_{r}}$$

$$A = - \frac{m}{{L}^{2}} \frac{{L}_{f} {C}_{f} - {L}_{r} {C}_{r}}{{C}_{f} {C}_{r}}$$

In the equations above, V is a vehicle speed; A is a stability factor of the vehicle; m is a mass of the vehicle; I_{Z} is a yaw moment of inertia of the vehicle; C_{f} is a front wheel equivalent cornering power; Cᵣ is a rear wheel equivalent cornering power; L_{f} is a distance between the center of gravity and a front axle; Lᵣ is a distance between the center of gravity and a rear axle of the vehicle; and L is a wheel base.

Moreover, at S6, the controller 4 sets the modified target side slip angle G_{S}(s)′ and the modified target yaw rate G_{Y}(s)′ by modifying the target side slip angle G_{S}(s) and the target yaw rate G_{Y}(s) with the target yawing direction α, as expressed by the equations below:

$${{G}_{S} ( s )}^{′} = {G}_{S} ( 0 ) [ \frac{{T}_{S} \cdot s + 1}{\frac{{s}^{2}}{{ω}_{n}^{2}} + \frac{2 ζ s}{{ω}_{n}} + 1} ] \cdot θ - α \\ {{G}_{Y} ( s )}^{′} = {G}_{Y} ( 0 ) [ \frac{{T}_{Y} \cdot s + 1}{\frac{{s}^{2}}{{ω}_{n}^{2}} + \frac{2 ζ s}{{ω}_{n}} + 1} ] \cdot θ + s α \qquad [ Eq . 5 ]$$

At S7, the controller 4 calculates a target front wheel steer angle δ_{f}(s) and a target rear wheel steer angle δᵣ(s) according to a linear two-degree-of-freedom model simulating the dynamic characteristics of a vehicle equipped with this control system and controlled by this control system as expressed below.

$${δ}_{f} ( s ) = \frac{m {L}_{r} V \cdot s + {LC}_{f}}{{LC}_{f}} {{G}_{S} ( s )}^{′} + \frac{{I}_{Z} \cdot s + m {L}_{v} V + \frac{{L}_{f} {LC}_{f}}{v}}{{LC}_{f}} {{G}_{Y} ( s )}^{′} \\ {δ}_{r} ( s ) = \frac{m {L}_{f} V \cdot s + {LC}_{r}}{{LC}_{r}} {{G}_{S} ( s )}^{′} + \frac{{I}_{Z} \cdot s + m {L}_{f} V + \frac{{L}_{r} {LC}_{r}}{v}}{{LC}_{r}} {{G}_{Y} ( s )}^{′} \qquad [ Eq . 6 ]$$

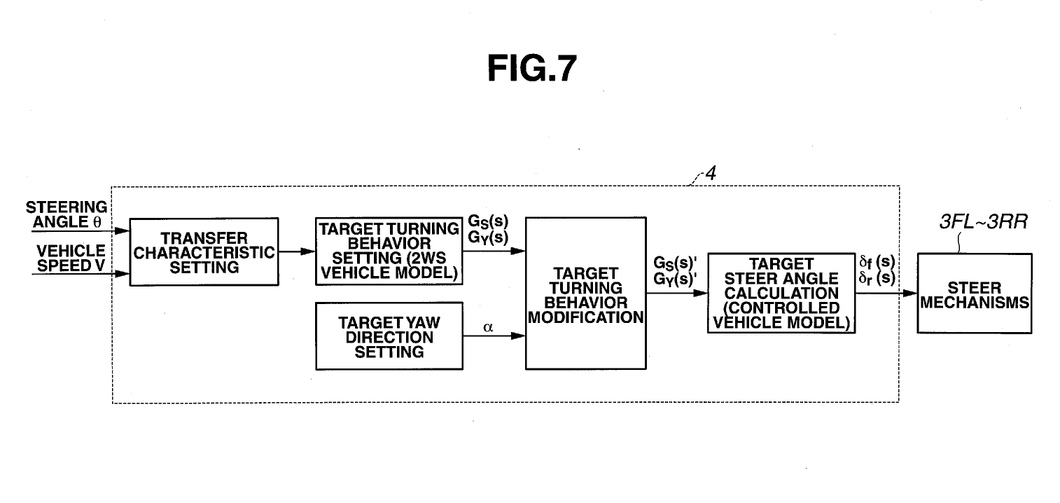

FIG. 7 is a block diagram showing the calculation process performed in the controller 4 of the second embodiment.

The controller 4 has a first (2WS) vehicle model simulating the dynamic characteristics of the front wheel steering (2WS) vehicle, and the controller 4 calculates the target side slip angle G_{S}(s) and target yaw rate G_{Y}(s) according to this vehicle model (at S4). By so doing, the controller 4 produces a steering feeling of two-wheel steering and restrains unnatural feeling in the driver. It is possible to change the target turning behavior G_{S}(s) and G_{Y}(s) by changing one or more specification data items of the vehicle model. Accordingly, the transfer function of the target turning behavior G_{S}(s) and G_{Y}(s) corresponding to steering angle θ is not determined uniformly.

Furthermore, the controller 4 has a second (4WS) vehicle model simulating the dynamic characteristics of its controlled vehicle having the four wheel steering system, and the controller 4 calculates the front wheel and rear wheel steer angles δ_{f}(s) and δᵣ(s) according to this vehicle model (at S7). By so doing, the controller 4 controls the steer angles of the front and rear wheels using feed forward control without sensing motion variables such as the yaw rate, lateral acceleration and side slip angle.

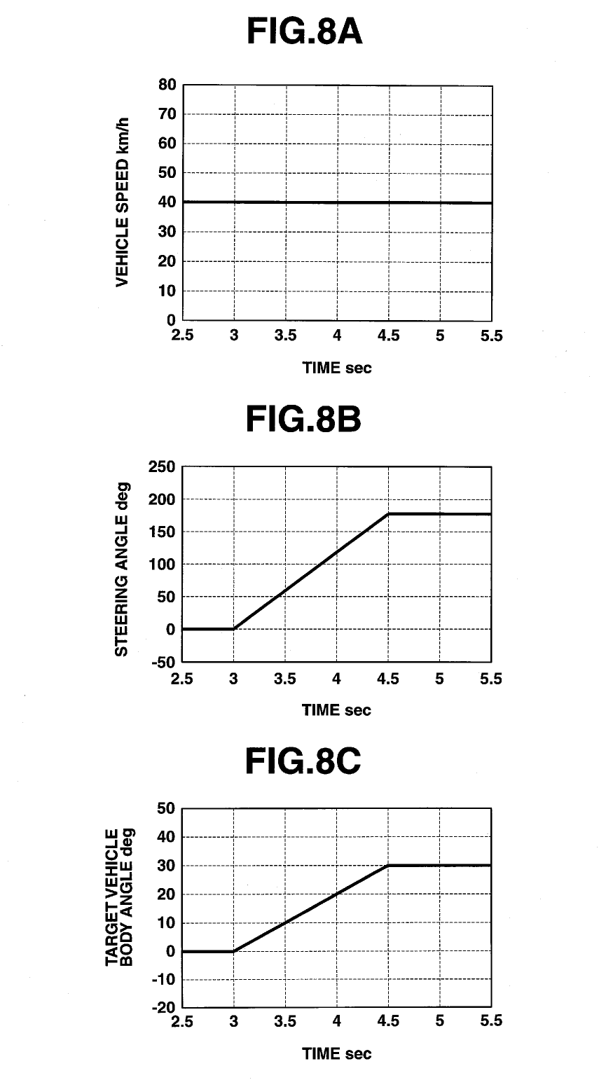

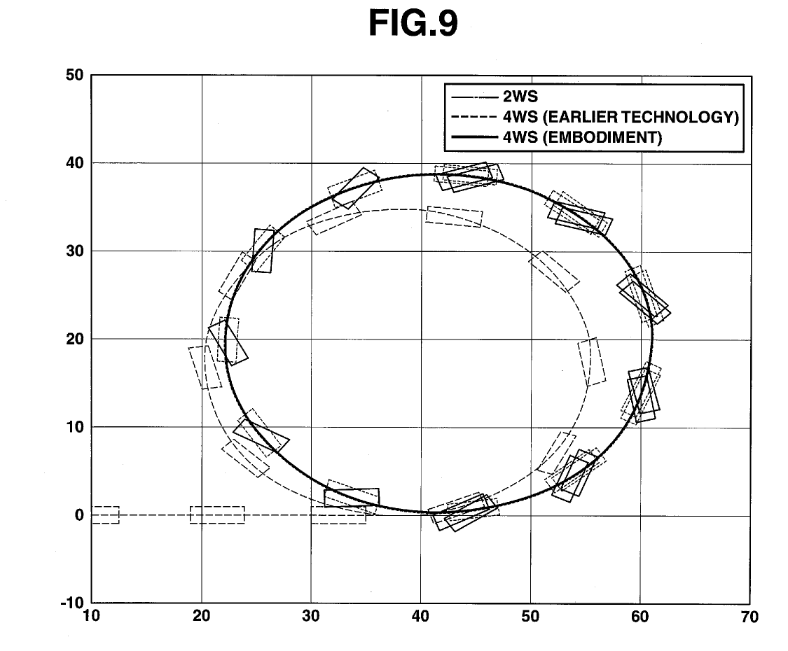

In an example shown in FIGS. 8A, 8B and 8C the target is set so that, when the steering angle θ is increased to 180 deg (corresponding to a lateral acceleration of 0.6 G) from a straight ahead operation having a vehicle speed of 40 km/h, then the yaw direction of the vehicle body is oriented at 30 deg on the inner side of the turn. In this case, as shown in FIG. 9, in contrast to a 4WS system of a comparative example of earlier technology, the 4WS system according to this embodiment can keep a course equivalent to a turning path of a 2WS system even in a region in which the vehicle does not turn geometrically.

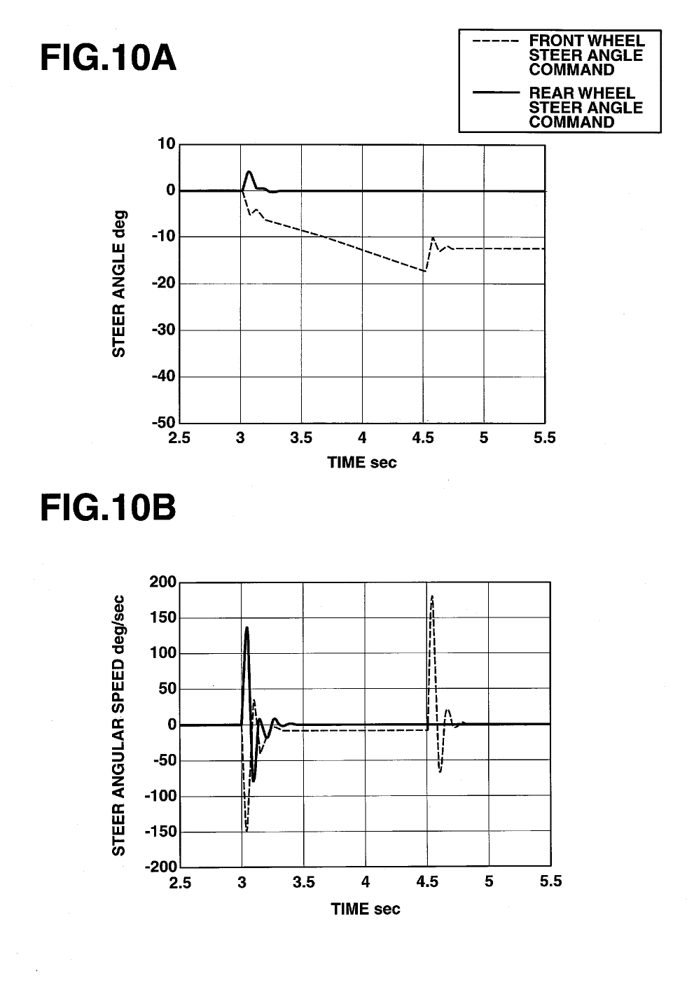

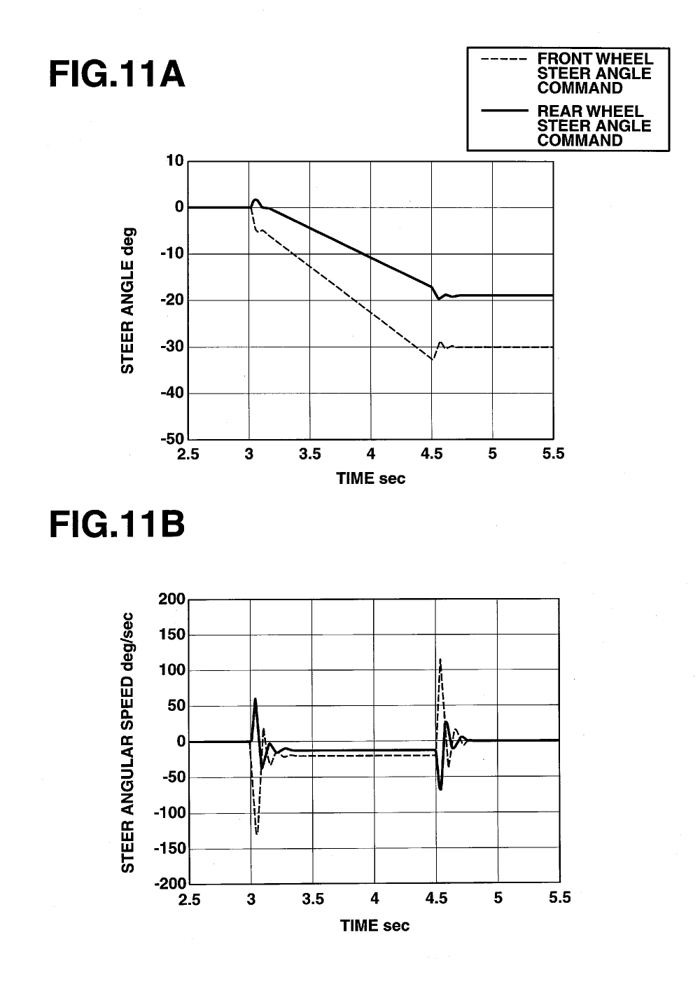

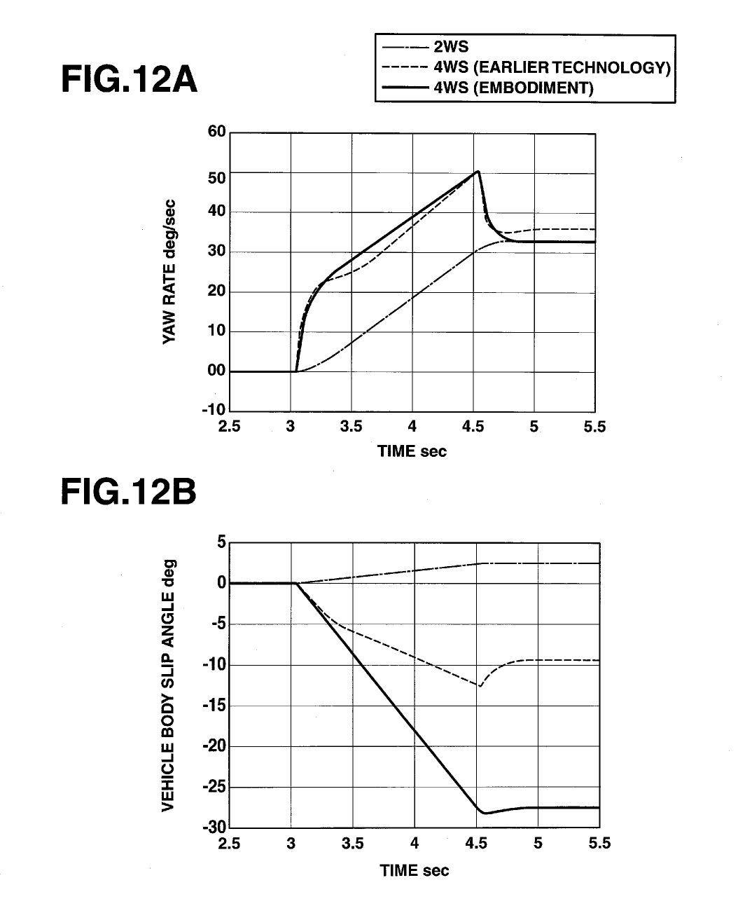

Furthermore, as compared to the 4WS system of the comparative example as shown in FIGS. 10A and 10B, the 4WS system according to this embodiment as shown in FIGS. 11A and 11B can restrain a sharp steer angle change, and thereby reduce the motor speed of the steer mechanisms 3i approximately by half. As shown in FIGS. 12A and 12B, as compared to the 4WS system of the comparative example, the 4WS system according to this embodiment can vary the yaw rate and side slip angle stably, restrain unwanted fluctuations, and thereby stabilize the vehicle turning behavior.

Effects of this second practical embodiment are as follows.

Firstly, the controller 4 uses the first vehicle model representing the dynamics of the front wheel steering vehicle to calculate the target vehicle side motion G_{S}(s) and target vehicle yaw motion G_{Y}(s). Therefore, the control system according to the second embodiment can control the course of the vehicle to the turning path of the vehicle model.

Secondly, the controller 4 uses the second vehicle model representing the dynamics of the four wheel steering vehicle to calculate the front and rear wheel steer angles δ_{f}(s) and δᵣ(s). Therefore, the control system according to the second embodiment can control the steer angles of the front and rear wheels in a feed-forward manner without the need for means for sensing a motion variable such as the yaw rate, lateral acceleration or side slip angle.

In the other effects and operations, the second embodiment is substantially identical to the first embodiment.

According to a third embodiment of the present invention, the front and rear wheel target steer angles δ_{f}(s) and δᵣ(s) are calculated so as to reduce a deviation between the actual vehicle turning behavior and the modified target turning behavior G_{S}(s)′ and G_{Y}(s)′.

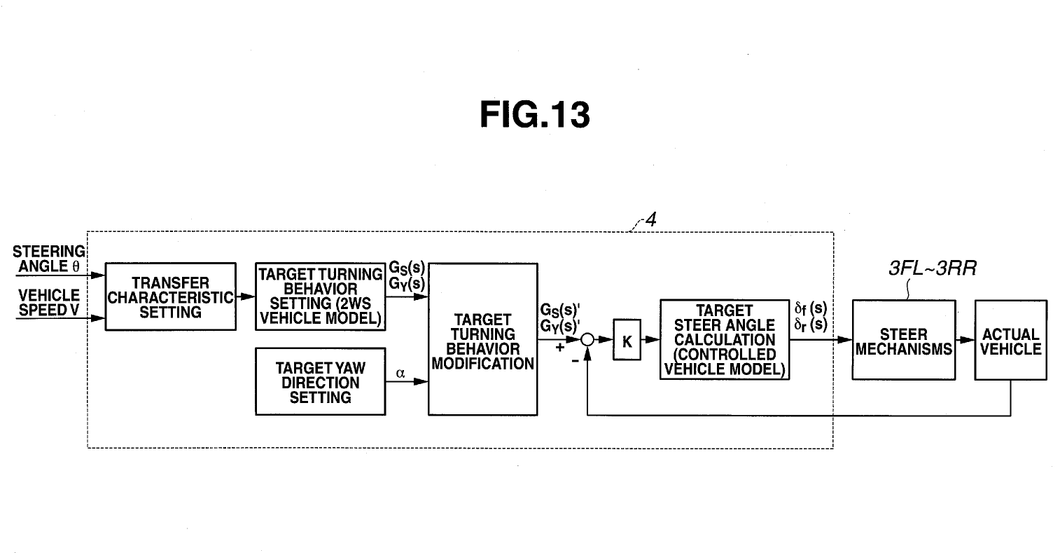

As shown in FIG. 13, a 4WS control system according to the third embodiment is arranged to sense an actual side slip angle and an actual yaw rate and to correct the modified target side slip angle G_{S}(s)′ and yaw rate G_{Y}(s)′ by multiplying a deviation of the sensed value from the modified value G_{S}(s)′ or G_{Y}(s)′ by a feedback gain. In the other respects, the third embodiment is substantially identical to the second embodiment.

The control system according to the third embodiment is operated as follows.

Instead of calculating the target steer angles δ_{f}(s) and δᵣ(S) of the front and rear wheels merely in accordance with the modified turning behavior G_{S}(s)′ and G_{Y}(s)′, the controller 4 according to the third embodiment makes further adjustment or correction on the modified target turning behavior G_{S}(s)′ and G_{Y}(s)′ in accordance with the deviation between the modified target turning behavior and the actual turning behavior. By so doing, the controller 4 optimizes the modified target turning behavior G_{S}(s)′ and G_{Y}(s)′ and determines the target steer angles δ_{f}(s) and δᵣ(s) adequately.

In the illustrated example shown in FIG. 13, the controller 4 is arranged to correct the modified target turning behavior G_{S}(s)′ and G_{Y}(s)′ in a feedback control manner. However, it is optional to employ a configuration to directly correct the target steer angles δ_{f}(s) and δᵣ(s) of the front and rear wheels in accordance with the deviation between the modified target turning behavior G_{S}(s)′ and G_{Y}(s)′ and the actual vehicle turning behavior. In this case, too, the same effects can be obtained as in the illustrated example.

Effects of this third practical embodiment are as follows.

The controller 4 is configured to calculate the target steer angles δ_{f}(s) and δᵣ(s) of the front and rear wheels in a manner to reduce the deviation between the actual turning behavior and the modified target turning behavior G_{S}(s)′ and G_{Y}(s)′. Therefore, the control system according to the third embodiment can control the front and rear wheel steer angles adequately in the manner of feedback control.

In the other effects and operations, the third embodiment is substantially identical to the second embodiment.

The preceding description has been presented only to illustrate and describe possible embodiments of the claimed invention. It is not intended to be exhaustive or to limit the invention to any precise form disclosed. It will be understood by those skilled in the art that various changes may be made and equivalents may be substituted for elements thereof without departing from the scope of the invention. Therefore, it is intended that the invention not be limited to the particular embodiments disclosed herein but that the invention can widely be adapted to steering systems formed with various layouts and will include all embodiments falling within the scope of the appended claims.

This application claims priority from Japanese Patent Application No. 2006-039647, filed 16 Feb. 2006, the contents of which are expressly incorporated herein by reference.

1. A vehicle turning behavior control apparatus comprising:
steer mechanisms configured to steer front and rear wheels, respectively, of the vehicle;
a turning behavior setting section configured to set a target vehicle turning behavior in accordance with a driver's steering operation;
a yaw direction setting section configured to set a target vehicle yaw direction independently of the turning behavior setting section;
a modifying section configured to modify the target vehicle turning behavior set by the turning behavior setting section, in accordance with the target vehicle yaw direction set by the yaw direction setting section;
a calculating section configured to calculate a target front wheel steer angle and a target rear wheel steer angle in accordance with the target vehicle turning behavior modified by the modifying section; and
a control section configured to control the steer mechanisms in accordance with the target steer angles calculated by the calculating section.

2. The turning behavior control apparatus according to claim 1, further comprising a steering angle sensing section configured to sense a steering angle caused by the driver's steering operation, wherein the turning behavior setting section is configured to set the target vehicle turning behavior in accordance with the steering angle.

3. The turning behavior control apparatus according to claim 2, wherein the turning behavior setting section is configured to set, as the target vehicle turning behavior, a target vehicle side motion and a target vehicle yaw motion.

4. The turning behavior control apparatus according to claim 3, wherein the modifying section is configured to modify the target vehicle side motion and the target vehicle yaw motion so as to make a turning path obtained from the target vehicle side motion and the target vehicle yaw motion after modification to correspond with a turning path obtained from the target vehicle side motion and the target vehicle yaw motion before the modification.

5. The turning behavior control apparatus according to claim 3, wherein the turning behavior setting section is configured to set the target vehicle side motion and the target vehicle yaw motion according to a first vehicle model simulating a dynamic characteristic of a front wheel steering vehicle.

6. The turning behavior control apparatus according to claim 3, wherein the modifying section is configured to decrease the target vehicle side motion and increase the target vehicle yaw motion by an amount corresponding to a vehicle yaw rate increase.

7. The turning behavior control apparatus according to claim 6, wherein the modifying section is configured to perform at least one of:
i) modify the target vehicle side motion by subtracting the target vehicle yaw direction from the product of the target vehicle side motion and the steering angle; and
ii) modify the target vehicle yaw motion by adding a derivative of the target vehicle yaw direction to the product of the target vehicle yaw rate and the steering angle.

8. The turning behavior control apparatus according to claim 6, wherein the modifying section is configured to perform at least one of:
i) modify the target vehicle side motion by subtracting an integral of the yaw rate increase from the product of the target vehicle side motion and the steering angle; and
ii) modify the target vehicle yaw motion by adding the yaw rate increase to the product of the target vehicle yaw motion and the steering angle.

9. The turning behavior control apparatus according to claim 1, wherein the calculating section is configured to calculate the target front and rear wheel steer angles according to a second vehicle model simulating a dynamic characteristic of a four wheel steering vehicle capable of steering front and rear wheels, respectively.

10. The turning behavior control apparatus according to claim 1, wherein the calculating section is configured to calculate the target front and rear wheel steer angles so as to reduce a deviation between an actual vehicle turning behavior and the target vehicle turning behavior.

11. A vehicle turning behavior control apparatus comprising:
a setting section configured to individually set a target vehicle turning path corresponding to a driver's steering operation and a vehicle direction with respect to the target vehicle turning path;
an operating section configured to simultaneously determine a target vehicle turning behavior to achieve the target vehicle turning path and the vehicle direction of a vehicle body with respect to the target vehicle turning path; and
a control section configured to control an actual vehicle turning behavior so as to achieve the target vehicle turning behavior.

12. A vehicle comprising:
a steering wheel;
front and rear wheels; and
the turning behavior control apparatus according to claim 1.

13. A vehicle turning behavior control apparatus comprising:
steering means for steering front and rear wheels, respectively;
turning behavior setting means for setting a target vehicle turning behavior in accordance with a driver's steering operation;
yaw direction setting means for setting a target vehicle yaw direction independently of the turning behavior setting means;
modifying means for modifying the target vehicle turning behavior set by the turning behavior setting means in accordance with the target vehicle yaw direction set by the yaw direction setting means;
calculating means for calculating a target front wheel steer angle and a target rear wheel steer angle in accordance with the target vehicle turning behavior modified by the modifying means; and
control means for controlling the steering means in accordance with the target front and rear wheel steer angles calculated by the calculating means.

14. A vehicle turning behavior control process comprising:
individually setting a target vehicle turning path of a controlled vehicle in accordance with a driver's steering operation and a target vehicle yaw direction of the controlled vehicle with respect to a traveling direction of the target vehicle turning path;
simultaneously determining a target vehicle turning behavior to achieve the target vehicle turning path and the vehicle direction with respect to the target turning path; and
controlling an actual vehicle turning behavior so as to achieve the target vehicle turning behavior.

15. A vehicle turning behavior control apparatus comprising:
setting means for individually setting a target vehicle turning path corresponding to a driver's steering operation, and a vehicle direction with respect to the target vehicle turning path;
operating means for simultaneously determining a target vehicle turning behavior to achieve the target vehicle turning path and the vehicle direction of a vehicle body with respect to the target vehicle turning path; and
control means for controlling an actual vehicle turning behavior so as to achieve the target vehicle turning behavior.

16. An apparatus as claimed in claim 15, further comprising:
steering means for steering front and rear wheels, respectively;
turning behavior setting means for setting a target vehicle turning behavior in accordance with a driver's steering operation;
yaw direction setting means for setting a target vehicle yaw direction independently of the turning behavior setting means;
modifying means for modifying the target vehicle turning behavior set by the turning behavior setting means in accordance with the target vehicle yaw direction set by the yaw direction setting means;
calculating means for calculating a target front wheel steer angle and a target rear wheel steer angle in accordance with the target vehicle turning behavior modified by the modifying means; and
control means for controlling the steer mechanisms in accordance with the target steer angles calculated by the calculating means.

17. An apparatus as claimed in claim 16, further comprising:
a steering angle sensing means for sensing a steering angle caused by the driver's steering operation, wherein the turning behavior setting means is arranged to set the target vehicle turning behavior in accordance with the steering angle.

18. An apparatus as claimed in claim 16, wherein the turning behavior setting means is configured to set, as the target vehicle turning behavior, a target vehicle side motion and a target vehicle yaw motion.

19. An apparatus as claimed in claim 18, wherein the modifying means is configured to modify the target vehicle side motion and the target vehicle yaw motion so as to make a turning path obtained from the target vehicle side motion and the target vehicle yaw motion after modification to correspond with a turning path obtained from the target vehicle side motion and the target vehicle yaw motion before the modification.

20. An apparatus as claimed in claim 18, wherein the turning behavior setting means is configured to set the target vehicle side motion and the target vehicle yaw motion according to a first vehicle model simulating a dynamic characteristic of a front wheel steering vehicle.

21. An apparatus as claimed in claim 18, wherein the modifying means is configured to decrease the target vehicle side motion and increase the target vehicle yaw motion by an amount corresponding to a yaw rate increase.

22. An apparatus as claimed in claim 21, wherein the modifying means is configured to perform at least one of:
i) modify the target vehicle side motion by subtracting the target vehicle yaw direction from the product of the target vehicle side motion and a steering angle; and
ii) modify the target vehicle yaw motion by adding a derivative of the target vehicle yaw direction to the product of the target vehicle yaw rate and a steering angle.

23. An apparatus as claimed in claim 21, wherein the modifying means is configured to perform at least one of:
i) modify the target vehicle side motion by subtracting an integral of the yaw rate increase from the product of the target vehicle side motion and a steering angle; and
ii) modify the target vehicle yaw motion by adding the yaw rate increase to the product of the target vehicle yaw rate and a steering angle.

24. An apparatus as claimed in claim 16, wherein the calculating means is configured to calculate the target front and rear wheel steer angles according to a second vehicle model simulating a dynamic characteristic of a four wheel steering vehicle capable of steering front and rear wheels, respectively.

25. An apparatus as claimed in claim 16, wherein the calculating means is configured to calculate the target front and rear wheel steer angles so as to reduce a deviation between an actual vehicle turning behavior and the target vehicle turning behavior.

26. (canceled)
